(19) United States
(12) Patent Application Publication
(10) Pub. No.: US 2008/0204742 A1
(43) Pub. Date: Aug. 28, 2008

(54) Method and System for Optimizing Surface Enhanced Raman Scattering

(76) Inventors: Nancy J. Halas, Houston, TX (US); Joseph B. Jackson, Houston, TX (US)

Correspondence Address: CONLEY ROSE, P.C.;David A. Rose, P. O. BOX 3267, HOUSTON, TX, 77253-3267, US

(21) Appl. No.: 11/573,365

(22) PCT Filed: Aug. 15, 2005
(86) PCT No.: PCT/US2005/028967

§ 371 Date: Aug. 20, 2007

Related U.S. Application Data
(60) Provisional application No. 60/601,319, filed on Aug. 13, 2004.

(51) Int. Cl. G01J 3/44

(52) U.S. Cl. 356/301; 977/773

(57) ABSTRACT

A substrate for enhanced electromagnetic spectroscopy of an analyte comprises a solid support and a plurality of individual nanoparticles affixed thereto, wherein the nanoparticles are designed to have an increased electromagnetic field strength and/or plasmon resonance frequency that is between the frequency of an incident electromagnetic radiation and the frequency of the Raman response from the analyte and wherein the Raman response is enhanced by the individual nanoparticles. The nanoparticles may comprise a shell surrounding a core and the thicknesses of the core and the shell are selected to produce a plasmon resonance frequency. The wavelength of the incident radiation may be between 200 nm and 20 microns. A method for carrying out spectroscopy comprises providing a light source having a frequency different from that of the analyte, selecting a nanoshell configuration, providing a plurality of nanoshells with that configuration, and affixing the nanoparticles to a support.

### STATEMENT REGARDING FEDERALLY SPONSORED RESEARCH OR DEVELOPMENT

This invention was made with government support under Grant F49620-03-C-0068 awarded by Air Force Office of Scientific Research. The United States government has certain rights in the invention.

### FIELD OF THE INVENTION

The present invention relates generally to a method and system for performing analysis of Surface Enhanced Raman Scattering (SERS) on an analyte. More particularly, aspects of the present invention relate to plasmonic nanoparticle substrates used for surface enhanced Raman scattering. Still more particularly, aspects of the present invention relate to selecting plasmonic nanoparticle substrates that maximize the electromagnetic field strength at a specific frequency.

### BACKGROUND OF THE INVENTION

Since the initial discovery of (SERS), understanding how the local electromagnetic environment enhances the substrate-adsorbate complex's spectral response has been of central importance. It has become increasingly evident that plasmon resonances of the metallic substrate provide intense, local optical-frequency fields responsible for SERS.

The lack of reliable techniques for controlling the properties of the local field at the metal surface has been a major experimental limitation in the quantification and understanding of SERS. A striking example of this is the series of experiments reporting enormous SERS enhancements of 10¹²-10¹⁵ for dye molecules adsorbed on surfaces of aggregated Au and Ag colloid films. The SERS enhancements reported in these experiments have been attributed to localized plasmons, or “hot spots,” occurring randomly across this film that fortuitously provide the appropriate electromagnetic nanoenvironment for large SERS enhancements. More recent studies have shown that localized plasmons giving rise to very large field enhancements can be formed at the junctions between adjacent nanoparticles. These plasmons can be described within the plasmon hybridization picture as dimer resonances. Likewise, self-similar geometries also provide a means for developing large field enhancements.

Several experimentally realizable geometries, such as triangles, nanorings, and nanoshells, support well-defined plasmon resonances whose frequencies can be controlled by judicious modification of the geometry of the nanoparticle. Each of these nanostructured geometries offers its own unique near field properties: plasmon resonant frequency, spatial distribution of the near field amplitude across the surface of the nanostructure, orientation dependence on polarization of the incident light wave, and spatial extent of the near field.

The near field properties of metallic nanoparticles can be calculated very precisely by a variety of methods, such as analytic Mie scattering theory for high-symmetry geometries, and numerical methods such as the discrete dipole approximation (DDA) and the finite difference time domain (FDTD) methods for nanoscale objects of reduced symmetry. It is thus possible to approach a convergence between the electromagnetic fields determined theoretically and those achievable experimentally for an increasing range of nanoscale metallic geometries, which will ultimately lead to the development of precisely designed nano-optical components for SERS and other applications. Such a near infrared optimized nanosensor for electromagnetic emission spectroscopy is likely to be of utility in a variety of biological studies and biomedical applications, such as bioassays, intracellular spectroscopy and molecular level diagnosis of early stage cancer.

SERS has been previously performed using solid metal films, isolated metal nanoparticles, and aggregates of nanoparticles. The plasmon resonance peak of metal nanoparticles can be altered to a limited degree by increasing the size of the metal nanoparticle or by aggregation of such particles. For example, the plasmon resonance peak for gold nanoparticles is generally approximately 525 nm, but will increase as the particles are made larger (e.g., increasing to approximately 600 nm as the particles are grown to a diameter of 120 nm). In order to achieve a plasmon resonance peak at longer excitation wavelengths, such as 633 nm or 785 nm, larger aggregates of particles are required. These longer wavelengths are useful for interrogation of biological or other samples where there is a background autofluorescence at lower wavelengths.

Isolated solid nanoparticles at their respective plasmon resonance (˜525 nm for gold, ˜430 nm for silver) have reported enhancement factors up to 10̂6. In order to perform SERS at wavelengths greater than the intrinsic plasmon resonance of the isolated colloid, it is necessary to aggregate the colloid.

The work of vanDuyne and others has identified “hot spots” in the aggregated colloids at these greater wavelengths; the SERS from the analyte at selected places within the field, or a “hot spot”, has achieved reported enhancements of greater than 10̂14. However, these “hot spots” are believed to be the result of a unique, and difficult to reproduce, association between the analyte and the aggregated particles at that particular location. This effect was further demonstrated by the work of Zhu.

Accordingly, there is a need for a reproducible method of SERS with significant enhancements at various excitation wavelengths.

As demonstrated by embodiments of this invention, the nanoparticle-based substrates described herein may be tunable to achieve strong electromagnetic fields at desired excitation wavelengths, resulting in significant enhancements from the individual nanoparticles rather than aggregates. Additionally, the electromagnetic peak can be tuned to wavelengths between the excitation and emission frequencies as desired. As a result, this invention demonstrates a platform for SERS from individual nanoparticles that can achieve enhancements of >10̂7 at the desired wavelengths, including wavelengths at 633 nm or greater.

### SUMMARY OF THE INVENTION

A substrate for enhanced electromagnetic spectroscopy of an analyte, the substrate comprises a solid support and a plurality of individual nanoparticles affixed to the solid support, wherein the individual nanoparticles are designed to have an increased electromagnetic field strength that is between a first frequency of an incident electromagnetic radiation and a second frequency of Raman response from the analyte and wherein the Raman response is enhanced by the individual nanoparticles. The individual nanoparticles may have a plasmon resonance frequency that is between a first frequency of an incident electromagnetic radiation and a second frequency of Raman response from the analyte and may enhance the Raman response by a factor of at least 10⁷.

The nanoparticles may be nanospheres comprising a shell surrounding a core material with a lower conductivity than the shell material, and the thickness of the core material and the thickness of the shell material may be selected to generate the plasmon resonance frequency. The core may comprise at least one of the following: silicon dioxide, gold sulfide, titanium dioxide, polymethyl methacrylate (PMMA), polystyrene, hydrogels, and macromolecules such as dendrimers. The shell comprises at least one of the following: gold, silver, copper, platinum, palladium, lead, and iron.

The solid support may comprise at least one of the following: an inert glass, a metal, a metal film, an oxide, or a living cell, and may be a reflective surface. The substrate of claim 1 wherein the nanoparticle may be bonded to the solid support covalently, electrostatically, or via adsorption. The nanoparticle may be selected from among spherical or elliptical shells, hollow nanoshells, multilayer nanoshells, nanorods, nanostars nanotriangles, and nanocubes.

The wavelength of the incident electromagnetic radiation is preferably between 200 nm and 20 microns and may be selected from among wavelengths that reduce the electromagnetic emission from molecules other than the analyte to be detected. The analyte may be a powder, or may be suspended in a liquid and the liquid may be biological fluid such as blood, cerebral spinal fluid, phlegm, mucous, or urine.

In other embodiments, a substrate for surface enhanced Raman spectroscopy of an analyte comprises a solid support and a plurality of individual nanoparticles affixed to the solid support, wherein the individual nanoparticles are designed to have a peak electromagnetic field strength when illuminated with an excitation wavelength that is equal to or greater than 600 nm.

### BRIEF DESCRIPTION OF THE DRAWINGS

FIG. 1 is a graph of the electromagnetic field (EMF) of multiple nanospheres at different wavelengths.

FIG. 2 is a graph of the electromagnetic field (EMF) of multiple nanospheres at different wavelengths.

FIG. 3 is a graph of Raman spectra.

FIG. 4 is representation of different nanoshell densities.

FIG. 5 is a table of nanoshell densities and clusters.

FIG. 6 is graph of absorption spectra for different nanoshell densities.

FIG. 7 is a graph of Raman spectra.

FIG. 8 is graph of Raman intensity versus density.

FIG. 9 is a display of calculated SERS optimization factor shown as a function of core radius and shell thickness.

FIG. 10 is a comparison of Raman modes to theoretical calculations.

FIG. 11 is a table of Raman enhancement as a function of core radius and shell thickness.

FIG. 12 is a display of extinction for smooth and rough nanoshells.

### DETAILED DESCRIPTION OF THE PREFERRED EMBODIMENT

Embodiments of the present invention include methods and apparatus for performing SERS analysis by maximizing a specific Raman mode or frequency of interest for an analyte exposed to incident electromagnetic radiation. One aspect of an embodiment of the present invention comprises choosing a specific geometric configuration for a nanoparticle, such as a nanosphere with a dielectric core and a conducting metallic shell, in order to maximize the inelastic electromagnetic emission. For example, by varying the core radius and/or the thickness of the shell, the electromagnetic field strength of the nanosphere can be altered in both the near-field and far-field regions for a given frequency. In another aspect of an embodiment of the present invention, the incident electromagnetic radiation frequency is selected so that the nanoparticle's maximum electromagnetic field strength is at a frequency between the incident electromagnetic radiation frequency and the frequency of the inelastic electromagnetic emission from the analyte. Embodiments of the present invention comprise methods incorporating the above-described steps to maximize the Raman response, as well as systems for performing such steps.

Research has indicated that the highest Raman response is obtained by maximizing the nanosphere's electromagnetic near-field strength at the wavelength corresponding to the midpoint of the excitation electromagnetic radiation frequency and the frequency of the Raman response of interest. Because the nanoparticle's electromagnetic field strength at a given wavelength will depend on the nanoparticle geometry, the amplitude of the inelastic electromagnetic emission is also dependent upon such geometry. As a result, a specific Raman response mode can be maximized by selecting the nanoparticle geometry that yields the highest electromagnetic field at the midpoint of the excitation (or incident) electromagnetic radiation frequency and the Raman response mode frequency. With regards to nanospheres, the core radius and shell thickness, as well as the materials of construction, can be selected to yield the maximum electromagnetic field at the midpoint frequency, thereby producing the maximum inelastic electromagnetic emission from the analyte.

For the sake of simplicity, the following discussion of embodiments of the present invention includes nanospheres with a dielectric core and a conducting shell as an example of a nanoparticle and a laser as a source for electromagnetic radiation. Embodiments of the present invention are not limited to such features and may include other nanoparticles such as elliptical shells, hollow nanoshells, nanorods, nanostars, nanotriangles, and nanocubes.

The development of nanospheres comprising a non-conductive inner core and an electrically conductive outer shell is well known in the art and is described in U.S. Pat. No. 6,344,272 by Oldenzburg, et al. (hereinafter the '272 patent), which is hereby incorporated by reference.

The use of an optical device as a support for a thin film formed by a matrix containing resonant nanoparticles is disclosed in U.S. Pat. No. 6,778,316 by Halas, et al. (hereinafter the '316 patent), also incorporated by reference.

The ability to shift the plasmon resonance of a nanosphere by adjusting the core:shell ratio is disclosed in U.S. Pat. No. 6,699,724, also incorporated by reference.

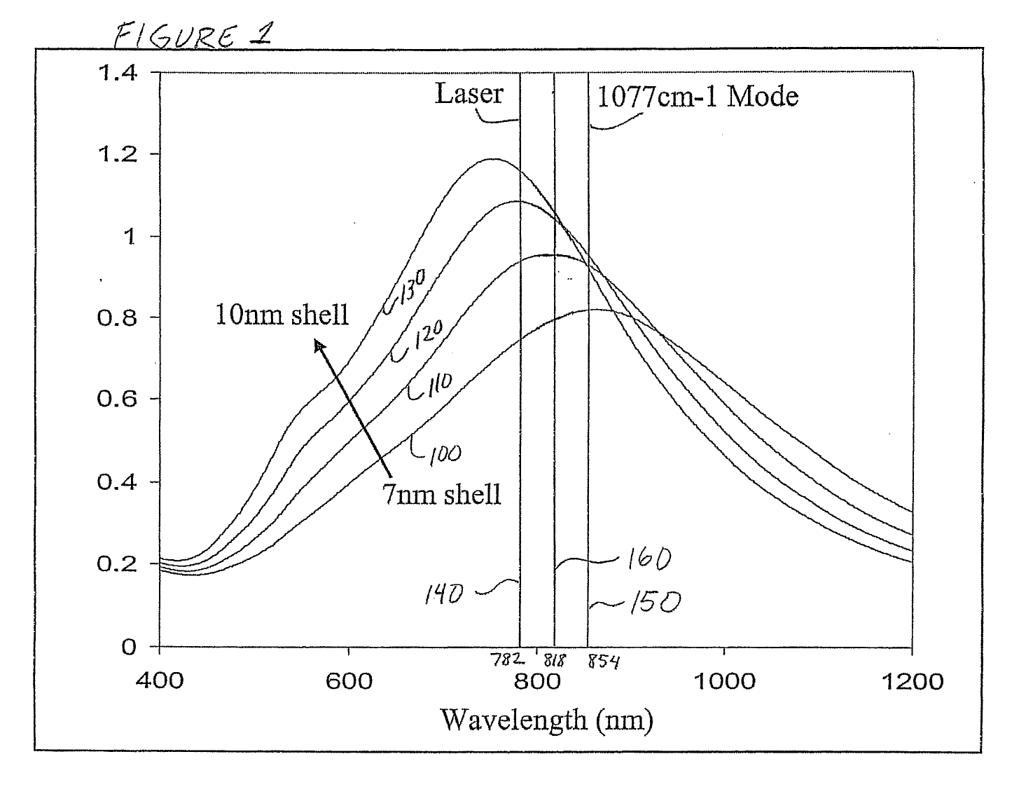

Referring now to FIG. 1, a graph is shown displaying the electromagnetic field (EMF) of multiple nanospheres at different wavelengths. The EMF measurements displayed in FIG. 1 were taken with air as a medium and correspond to nanospheres with a silica core with an 81 nm radius and silver shells with varying thicknesses ranging from 7 nm to 10 nm. A graph 100 corresponds to a nanosphere with a 7 nm shell, a graph 110 corresponds to a nanosphere with an 8 nm shell, a graph 120 corresponds to a nanosphere with a 9 nm shell and a graph 130 corresponds to a nanosphere with a 10 nm shell.

A line 140 representing the 782 nm laser excitation frequency and a line 150 representing the 1077 cm⁻¹ Raman mode shift (which corresponds to 854 nm in this embodiment) are also displayed on FIG. 1. A line 160 is depicted at 818 nm, the midpoint between the 782 nm excitation frequency and the 854 nm frequency corresponding to the 1077 cm⁻¹ Raman mode shift.

As previously mentioned, research has indicated that the maximum response for a specific Raman mode shift is obtained by maximizing the electromagnetic field for the frequency at the midpoint of the excitation frequency and the Raman mode shift frequency. In the graph shown in FIG. 1, it can be seen that for the particular nanoshell thicknesses displayed, the 10 nm shell nanosphere possesses the maximum electromagnetic field at the 818 nm midpoint frequency. Therefore, the 10 nm shell nanosphere will produce a greater response for the 1077 cm⁻¹ Raman mode shift and 782 nm excitation laser than the other nanosphere shell thicknesses displayed in FIG. 1.

It should be noted that while the parameters used in FIG. 1 resulted in the thickest nanoshell being the optimum configuration, such is not always the case. If the midpoint is shifted to a higher frequency (due to either an increase in the incident light frequency or a change in the Raman mode of interest), it is possible that the 10 nm shell will not yield the highest EMF at the frequency of interest.

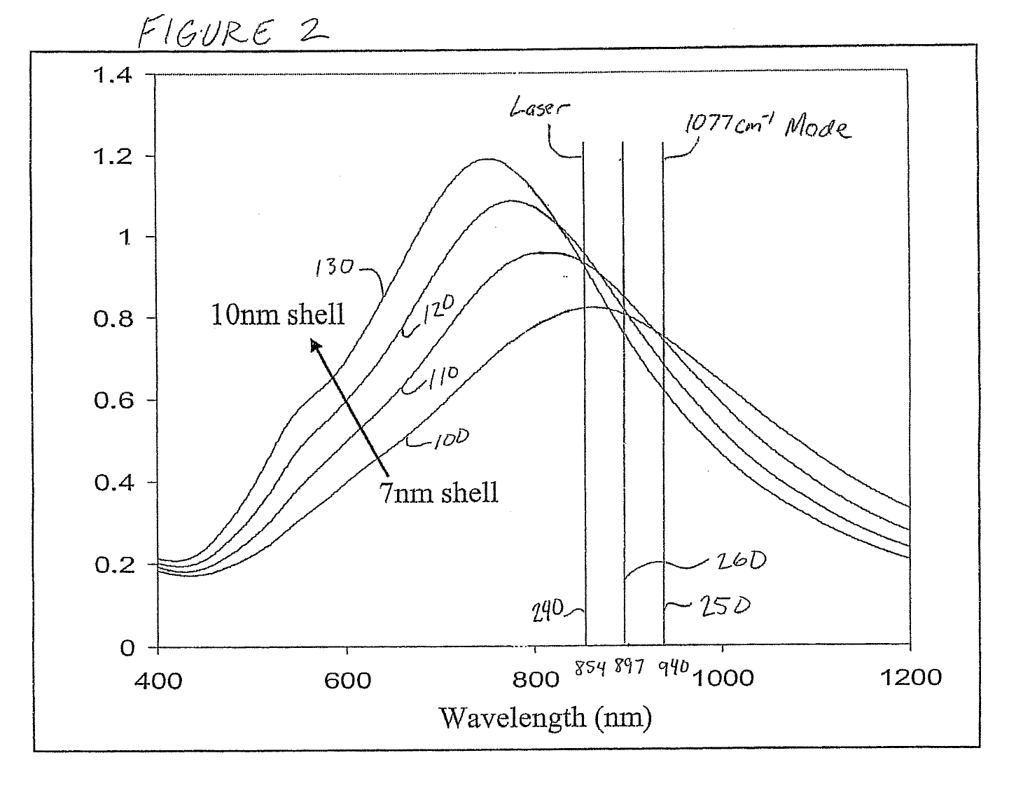

For example, now referring to FIG. 2, the EMF graphs are shown for the same set of nanosphere parameters displayed in FIG. 1. Graphs 100, 110, 120 and 130 represent EMF measurements for 7 nm, 8 nm, 9 nm, and 10 nm shell thicknesses, respectively. However, as shown in FIG. 2, if the incident light frequency is set at 854 nm (represented by a line 240), the 1077 cm⁻¹. Raman mode shift is now at 940 nm (represented by a line 250), resulting in a midpoint at 897 nm (represented by a line 260). As shown, line 260 intersects plots 100, 110, 120 and 130 at differing EMF values. It can be seen from FIG. 2 that line 110 intersects line 260 at the highest EMF value. Therefore, for the various shell thicknesses listed in FIG. 2, the 8 nm shell thickness represented by line 110 will yield the greatest Raman response for the 1077 cm⁻¹ shift with an excitation frequency of 854 nm. It should be noted that other nanosphere configurations besides those depicted in FIG. 2 may result in a higher EMF and Raman response.

As demonstrated in the discussion of FIGS. 1 and 2, if the excitation frequency and Raman frequency are known, as well as the EMF graphs for a group of nanospheres, a nanosphere can be selected from the group to yield the maximum Raman response for an analyte. Similarly, if a specific nanosphere must be used for a SERS analysis and the Raman shift for an analyte is known, the frequency of the excitation laser can be selected so that the maximum EMF value of the nanosphere is between the incident light frequency and the Raman response frequency. For example, referring back now to FIG. 1, it can be seen that the peak EMF value for the 8 nm shell (represented by line 110) is at or very near the 818 nm midpoint of the excitation and 1077 cm⁻¹ shift frequencies. In this case, the 782 nm excitation frequency would be the optimum frequency for the 1077 cm⁻¹ Raman mode used with an 8 nm shell nanosphere.

Independent control of the core and shell dimensions of nanoshells offers a valuable opportunity to systematically control the plasmon resonance frequency of a nanostructure and therefore maximize the electromagnetic near-field strength at a specific frequency. The plasmon resonant frequency of a nanoshell can be tuned from the visible region of the spectrum into the infrared, giving rise to a host of useful applications. The plasmon resonances for Au and Ag nanoshells in this wavelength region are quite similar. The tunable plasmon frequency allows one skilled in the art to design substrates with plasmon resonances shifted far away from the electronic resonances of an adsorbate molecule, providing a strategy for separating the electromagnetic from the chemical effects in SERS. In addition, the spherical symmetry of the nanoshell provides a simple theoretical strategy for analyzing the near field at the nanoparticle surface. Previously reported solution phase measurements of para-mercaptoaniline (pMA) on Ag nanoshells showed that the magnitude of the SERS enhancement for a saturated monolayer of nonresonant molecules bound to the nanoshell surface could be controlled by nanoparticle geometry with precise, quantitative agreement between theory and experiment.

In another aspect of embodiments of the invention, electromagnetic emission spectroscopy such as SERS can be used to determine the identity of an analyte based on a change in the Raman response of a chemical moiety. For example, for a given set of parameters, suppose the Raman response is known for chemical moiety when it is not in the presence of the analyte (hereinafter referred to as the “first” Raman response). The Raman response for the chemical moiety will be different when it is in the presence of the analyte (hereinafter referred to as the “second” Raman response). By examining the differences between the first and the second Raman responses for the chemical moiety, the identity of the analyte can be determined. This method is particularly useful when the analyte is not suited for direct SERS analysis.

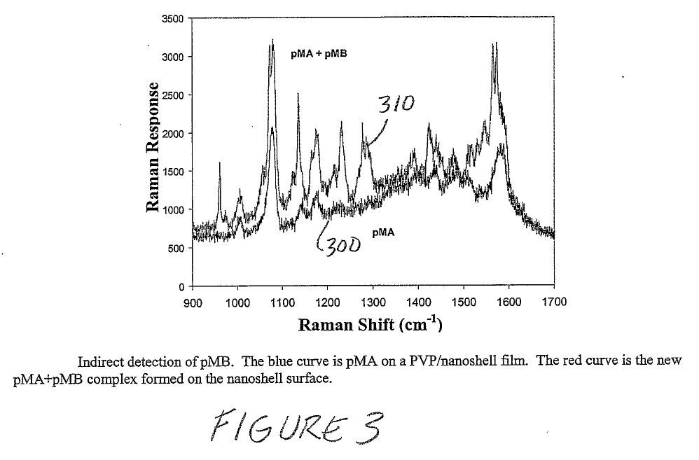

For example, a binding moiety is adsorbed on the nanoshell surface, and a Raman spectra is obtained. The binding moiety can be chosen such that it has a distinctive Raman spectrum and will chemically bind to the molecule of interest. The nanoshell/moiety substrate is then submerged in a solution of the molecule of interest. The presence of the molecule of interest is detected by changed in the Raman spectra of the substrate This is demonstrated by the following example: para-mercaptoaniline (pMA) is adsorbed onto a polyvinylpridine (PVP)/nanoshell film and a Raman spectra is obtained, shown as plot 300 in FIG. 3. This film is then placed in a 100 μM solution of para-mercaptobenzoic acid (pMB) and EDC is added. The EDC will chemically attach the amine group of pMA to the carboxylic acid of the pMB forming an amide group. The Raman response is measured and characteristic peaks of the amide group around ˜1235 cm⁻¹ are observed as plot 310 in FIG. 3. This demonstrates the potential of nanoshell films in molecular detection whereas the only requirement on the molecule to be detected is an available carboxylic group.

In a related application, embodiments of the present invention can be used to detect an alteration in an environmental condition to which the analyte is exposed. For example, if a “base” Raman response is known for an analyte exposed to a certain pH or temperature, an alteration in the temperature or pH can be detected by measuring the “affected” Raman response. If the effect of the environmental condition on the Raman response is known, then a measurement of the change in the base and affected Raman responses will allow the new environmental condition to be determined.

In yet another aspect of embodiments of the present invention, the use of nanoparticles coupled to a fixed support addresses a problem associated with previous SERS analysis performed in a solution phase geometry. The use of a solution phase geometry to perform SERS results in significant re-absorption of the Stokes and anti-Stokes backscattered light by the resonant nanoshell absorbers. This re-absorption limits the measured SERS enhancements to a maximum of ˜10⁶.

Embodiments of the present invention address the issue of re-absorption of the Stokes and anti-Stokes backscattered light in a solution phase geometry. In one embodiment, Ag and Au nanoshells are used as SERS substrates, where the nanostructures are deposited as films onto an inert glass substrate or other solid support. This simpler collection geometry yields much larger SERS enhancements relative to the solution phase, evaluated by direct experimental comparison with the unenhanced Raman signal of the adsorbate molecule (i.e., the analyte). In other embodiments of the present invention, nanoshells can serve as a standalone SERS nanosensor of sufficient sensitivity. The ability to significantly increase the Raman response by tuning the individual nanospheres, rather than relying on “hotspots” created in aggregates of nanoparticles, simplifies the design and fabrication of the substrate used in SERS analysis.

### Experimental

To confirm the principles disclosed herein, Au nanoshells were fabricated and then deposited onto poly-4-vinylpyridine (PVP) functionalized glass substrates. Glass substrates were first cleaned in a piranha cleaning solution (70% sulfuric acid: 30% hydrogen peroxide), rinsed with milli-Q water, and submerged in a 1% solution of PVP (100 mg PVP/10 mL ethanol) for 12 hours. The substrates were then removed from the PVP solution, rinsed with ethanol, and submerged in an aqueous Au nanoshell suspension. The Au nanoshells fabricated in these embodiments had a silica core radius of 94 nm and a Au shell thickness of ˜9 nm, as determined by comparing UV/Vis spectroscopy and Mie scattering theory, and independently verified by electron microscopy. The nanoshell deposition time was varied from 15 minutes to 24 hours to obtain a variety of nanoshell particle densities in the films. To obtain the highest nanoshell densities, it was necessary to neutralize the nanoshell surface charge by the addition of 3 mg of sodium chloride 12 hours into the deposition process. Finally, the PVP/nanoshell films were submerged in a 100 μM solution of pMA in ethanol for 3 hours to ensure saturation of the available nanoshell surface.

Absorption spectra were obtained using a Cary 5000 UV/Vis/NIR spectrophotometer in the range of 400 nm to 2000 nm. Raman spectra were obtained with a Renishaw micro-Raman spectrophotometer using a 782 nm excitation laser, 2 μm diameter spot size, and a 30 sec acquisition time. PVP/nanoshell films were sputter coated with a thin (˜10 nm) layer of Au for analysis in a Phillips FEI XL-30 Environmental Scanning Electron Microscope (SEM). The SEM analysis of these nanoshell films is presented first for clarity.

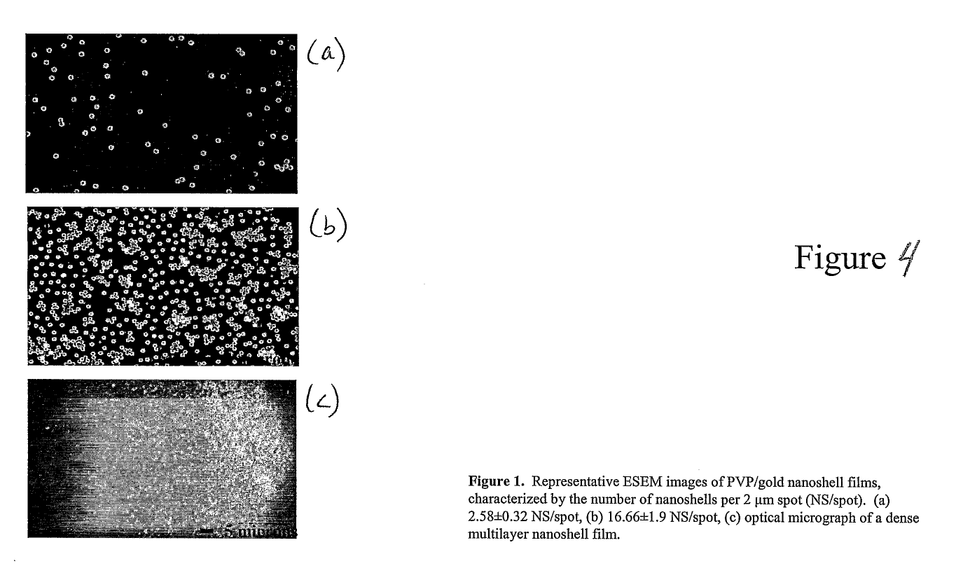

The intensity dependence of the SERS response was evaluated for nanoshells with monolayer coverage of pMA, as a function of nanoparticle density. This was accomplished by preparing films of increasing nanoparticle density ranging from <3 Au nanoshells in the beam spot of a Raman microscope to dense multilayer films for SERS studies. Representative images of these films are shown in FIG. 4. Each Au nanoshell film was analyzed by using at least 20 SEM images at 2000× magnification and 10 images at 800× magnification. The film images were analyzed by counting the number of nanoshells in the entire image area, tabulating the number of isolated nanoshells, the number of aggregates, and the number of nanoshells in each of the aggregates. FIG. 4 displays representative ESEM images of PVP/gold nanoshell films, characterized by the number of nanoshells per 2 μm spot (NS/spot). (a) 2.58±0.32 NS/spot, (b) 16.66±1.9 NS/spot, (c) optical micrograph of a dense multilayer nanoshell film.

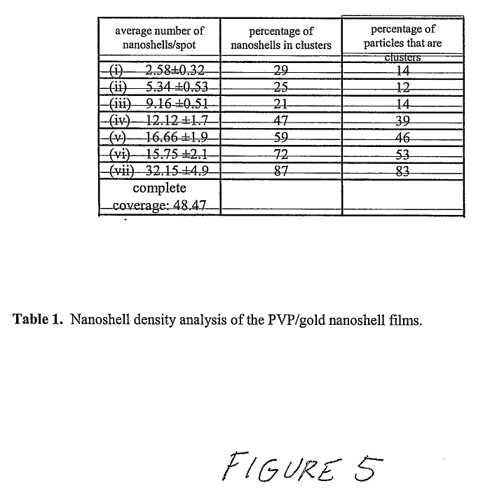

Nanoshells were considered to be in an aggregate only if they appeared to be in contact with another nanoshell. With some larger aggregates it was necessary to estimate the number of nanoshells present by dividing the area of the aggregate by the area of a single nanoshell. All nanoshell densities are tabulated as the number of nanoshells per 3.14 μm², consistent with the 2 micron diameter sampling area of the microRaman instrument. The individual and aggregate nanoshell densities for the series of PVP/gold nanoshell films are tabulated in FIG. 5. The percentage of nanoshells in a cluster, or equivalently the percent probability that a nanoshell probed in this sample was part of an aggregate, was determined by dividing the number of nanoshells in a cluster by the total number of nanoshells in that sample. The percentage of aggregates was determined by normalizing the number of nanoshell aggregates by the total number of particles (the number of aggregates plus the number of free nanoshells). This is the percent probability that the laser spot is probing an aggregate during the Raman spectrum acquisition.

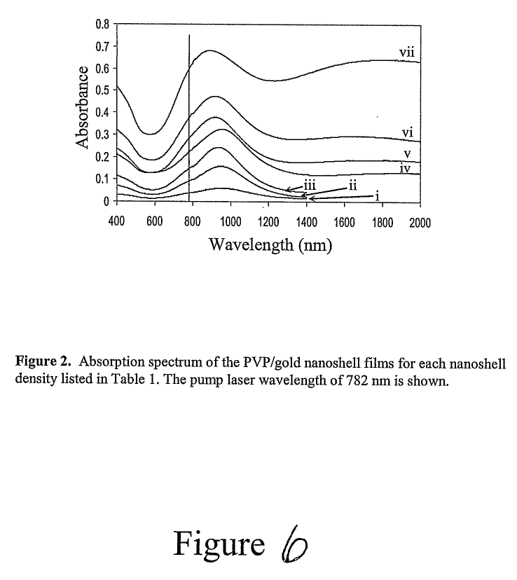

The UV/Vis spectrum of the previously-described nanoshell films as a function of nanoshell density is shown in FIG. 6, which displays the absorption spectrum of the PVP/gold nanoshell films for each nanoshell density listed in FIG. 5. The pump laser wavelength of 782 nm is also shown.

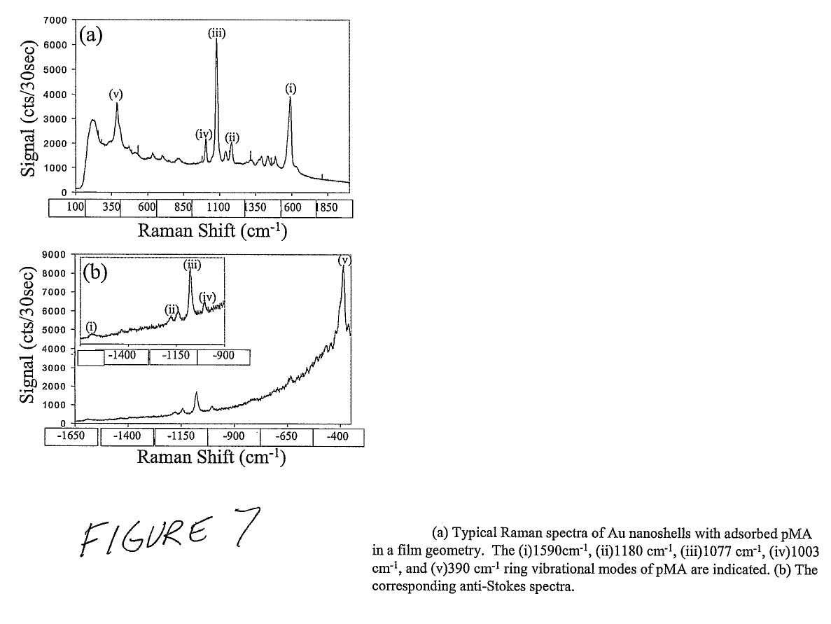

This spectrum indicates two important features: the isolated nanoshell plasmon resonance corresponds to the peak at ˜950 μm and the nanoshell aggregate resonance which becomes apparent at ˜1800 nm as the nanoshell density increases. At the highest coverages, a significant fraction of the overall nanoshell film plasmon response has shifted into the infrared region of the spectrum. However, the curves in FIG. 6 are shown as measured, indicating the plasmon response at the single nanoshell resonance nonetheless increases with an increasing number of nanoshells. To sample variability of the SERS spectrum across each PVP/nanoshell film, at least 30 Raman spectra were taken at random locations on each sample. A representative Stokes and anti-Stokes SERS spectrum of pMA on a nanoshell film is shown in FIG. 7. In section (a) of FIG. 7, typical Raman spectra of Au nanoshells with adsorbed pMA in a film geometry are displayed. The (i)1590 cm⁻¹, (ii)1180 cm-1, (iii)1077 cm-1, (iv)1003 cm-1, and (v)390 cm-1 ring vibrational modes of pMA are indicated. In section (b) of FIG. 7 displays the corresponding anti-Stokes spectra.

Each Raman spectrum was analyzed by subtracting the baseline from the peak magnitude at each specific Raman mode. This analysis was confined to the 390 cm⁻¹, 1077 cm⁻¹ and 1590 cm⁻¹ modes because they were the only observable modes at the lowest nanoshell densities used.

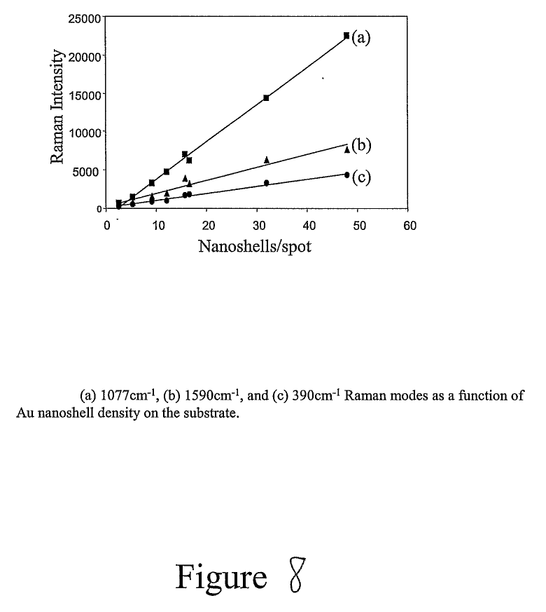

Magnitudes of these three Raman modes as a function of nanoshell density on each film are shown in FIG. 8. Different Raman modes for 1077 cm⁻¹, 1590 cm⁻¹, and 390 cm⁻¹ are depicted as lines (a), (b), and (c) as a function of Au nanoshell density on the substrate.

A linear response of the Raman mode intensities with nanoshell density is clearly observed, extending across the range of densities shown in FIG. 5 to a maximum density corresponding to the dense multilayer film shown in section (c) of FIG. 4. The linear dependence over this broad range indicates that the SERS response for nanoshells of these internal dimensions and at this pump laser wavelength is driven by the single nanoshell resonance response, not that of nanoshell dimers or aggregates. The maximum observed variation in the magnitudes of the Raman modes was ˜25%, obtained by sampling multiple spots across each sample. This error is just slightly larger than the statistical deviation in the number of nanoshells per spot shown in FIG. 5 (a maximum of ˜15%).

The SERS response of nanoshell films observed here is dramatically different than the Raman response of solid Au colloidal aggregate films as a function of nanoparticle density. Zhu, et al. recently performed an experiment with films composed of solid Au colloid and the same adsorbate molecule, at an excitation wavelength of 632 nm. For solid Au nanoparticles, this pump wavelength is resonant with the plasmon response of the “dimer” or aggregate plasmon, and off-resonance with respect to the single nanoparticle plasmon response. In these experiments a drastically different behavior was observed: only a minimal SERS response was reported until the solid colloid particle density exceeded a threshold corresponding to the onset of nanoparticle aggregates in the films, whereupon a dramatic supralinear increase in the Raman response was observed.

The Raman enhancement, G, is measured experimentally by direct comparison as (17, 34):

$$G = \frac{{RS}^{ENH} * [ reference ]}{{RS}^{REF} * [ sample ]} \qquad ( 1 )$$

Where RS^{ENH} and RS^{REF} are the measured Raman magnitudes and [sample] and [reference] are the estimated number of molecules in the enhanced and reference samples, respectively. The number of molecules in the sample was estimated using the average number of nanoshells per spot, the surface area of the nanoshell, and the packing density of pMA on the surface. This assumes that the entire nanoshell surface area contributes to the Raman response and is a conservative estimate, essentially a lower bound, of the Raman enhancement. The density of neat pMA (1.06 g/cm³) and the parameters of the optical beam are used to estimate the number of molecules in a non-enhanced sample, as 3.14×10¹³ molecules. The enhancement is the weighted ratio of the measured Raman intensities of the enhanced signal vs. the non-enhanced signal. The observed Raman response is independent of nanoshell density, as would be expected if the response were attributable to the individual nanoshell plasmon response. The average Raman enhancement of the 1077 cm⁻¹, 1590 cm⁻¹, and 390 cm⁻¹ modes are 2.21±0.42×10⁸, 1.04±0.19×10⁸, and 5.72±0.48×10⁷, respectively. This again reinforces the conclusion that when the single nanoshell plasmon is resonant with the Raman pump laser the individual nanoparticles give rise to the large Raman enhancements observed.

In addition, Ag nanoshells were constructed using 39 nm, 58 nm, 81 nm, and 94 nm radius silica cores, upon which Ag shells ranging from 7 nm to 18 nm were deposited. Following fabrication, UV/Vis spectroscopy measurements were correlated with Mie scattering theory for each nanoshell sample to verify core diameter and shell thickness. This showed that deviations in the shell thicknesses of ˜1 nm were present in all nanoshell samples. The Ag nanoshell films fabricated by repeatedly evaporating 300 μL aliquots of ˜10⁸ particles/mL nanoshell suspension onto a 7 mm² area of a glass microscope slide until complete surface coverage is achieved. pMA was deposited onto the nanoshell film by evaporating 10 μL of a 10 μM solution of pMA in ethanol.

In these embodiments of the present invention, Ag nanoshell films were used to investigate the Raman response as a function of nanoshell core and shell dimensions. Dense nanoshell films were used exclusively in these embodiments, to ensure the same nanoshell densities per unit surface area and hence the same number of molecules probed in each measurement. This allows for the direct comparison of SERS enhancements from nanoshells of differing dimensions. The signal strength of the 1590 cm⁻¹, 1180 cm⁻¹, 1077 cm⁻¹, 1003 cm⁻¹, and 390 cm⁻¹ ring modes of pMA were monitored as a function of Ag shell thickness for four different silica core radii. These Raman modes are indicated in the spectrum shown in FIG. 7.

The calculation of the relative dependent Raman response due to the local electromagnetic field at a nanoshell surface follows the method of Kerker, Wang, and Chew. The field exciting the molecule is taken as the sum of the incident plane wave and the local electromagnetic field on the nanoshell surface as calculated by Mie scattering theory. The excited molecular layer on the nanoshell is treated as a layer of noninteracting dipoles all oriented perpendicular to the nanoshell surface with a molecular polarizability taken as unity and radiating at the Stokes shifted frequency. This models a monolayer coverage of Raman active molecules where the C₂ᵥ axis of all molecules are perpendicular to the nanoshell surface. The Raman shifted electromagnetic field contribution is the sum of the electromagnetic field of the molecule's dipole and the nanoshell response at the Stokes shifted frequency ωₛ:

E_{Raman}(r,ωₛ)=E_{dipole}(r,ωₛ)+Eₛₕₑₗₗ(r,ωₛ) (2)

The total electromagnetic contribution to the SERS process is generally considered to be proportional to the product of field contributions at the incident (ωₒ) and shifted frequencies. Therefore, the measured Raman response should be proportional to |Eₛₕₑₗₗ(ωₒ)|²|E_{Raman}(ωₛ)|². This SERS optimization factor, |Eₛₕₑₗₗ(ωₒ)|²|E_{Raman}(ωₛ)|², is then calculated at each point on the nanoshell surface, assuming a monolayer of a molecule covering the surface of the nanoshell, and allowing for a coverage of 0.3 nm² per molecule. |Eₛₕₑₗₗ(ωₒ)|²|E_{Raman}(ωₛ)|² is averaged over the surface of the nanoshell, which is justified because the response of a complete layer of dipoles at the nanoshell surface is being modeled. It should be emphasized that this is not a calculation of the overall Raman enhancement, but rather a relative comparison of the electromagnetic response as a function of nanoshell geometry, under the same experimental conditions.

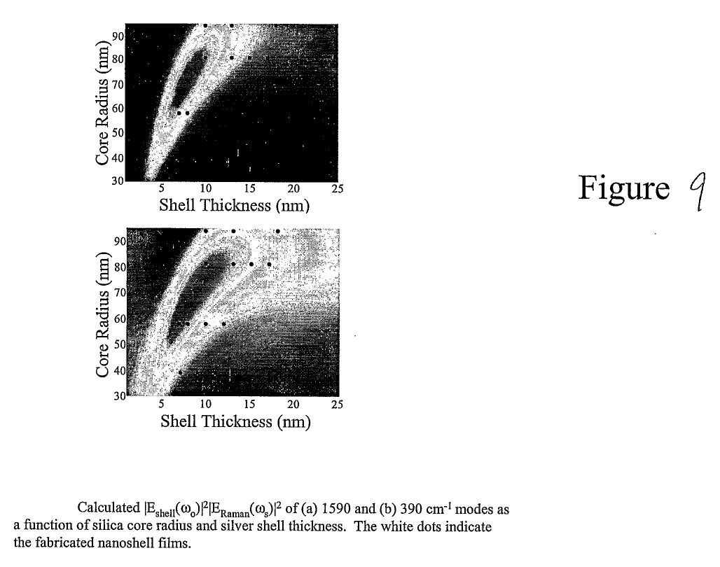

The calculated SERS optimization factor is shown as a function of core radius and shell thickness for the 1590 cm⁻¹ (depicted in graph (a) above) and 390 cm⁻¹ (depicted in graph (b) below) Stokes modes in FIG. 9. This is the normalized Raman optimization factor for these two modes as a function of core radius and shell thickness for an excitation wavelength of 782 nm. The circles in FIG. 9 correspond to the specific Ag nanoshell dimensions fabricated in certain embodiments of the present invention. The optimization factor is greatest at the center of the dark area that is surrounded by the lighter areas.

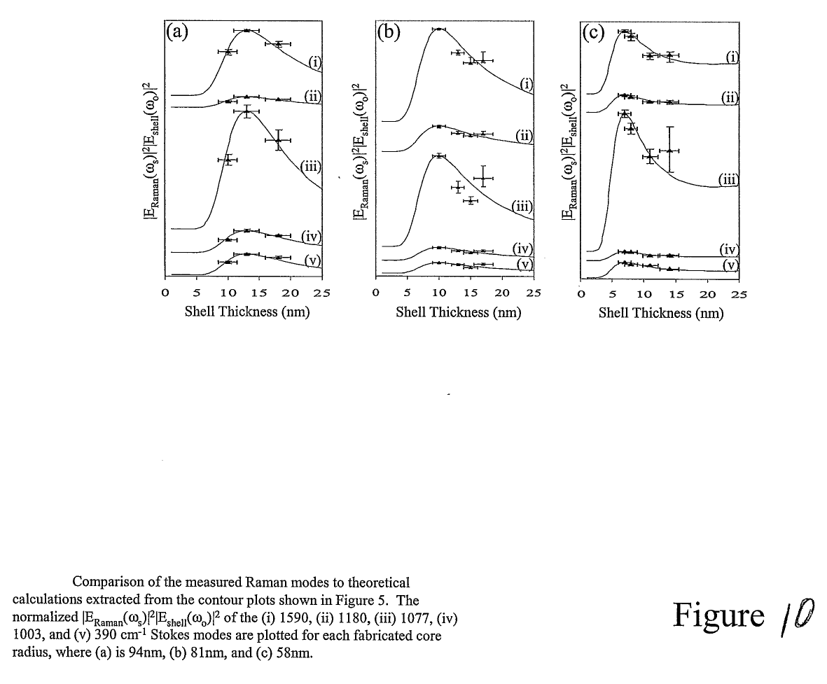

The measured Raman spectra are compared to the electromagnetic theory in FIG. 10, which displays a comparison of the measured Raman modes to theoretical calculations extracted from the contour plots shown in FIG. 5. The normalized |ERaman(ωs)|2|Eshell(ωo)|2 of the (i) 1590, (ii) 1180, (iii) 1077, (iv) 1003, and (v) 390 cm-1 Stokes modes are plotted for each fabricated core radius, where (a) is 94 nm, (b) 81 nm, and (c) 58 nm

For each mode, |Eₛₕₑₗₗ(ωₒ)|²|E_{Raman}(ωₛ)|² is plotted for a specific core radius as a function of shell thickness. |Eₛₕₑₗₗ(ωₒ)|²|E_{Raman}(ωₛ)|² is scaled and offset for comparison to measured values. The y-axis error bars arise from standard deviations between different nanoshell samples as well as different locations on the same sample. The x-axis error bars are the shell thickness deviations calculated from Mie scattering theory, assuming a Gaussian distribution in shell thickness. The excellent agreement of the measured and calculated SERS response of nanoshells in FIG. 6(a), (b), and (c) indicates that the SERS response follows the single nanoshell electromagnetic response in this geometry when the individual nanoshells are tuned near the excitation and Stokes frequencies. Data was also acquired in the case of the single nanoshell plasmon resonance blue shifted from the excitation wavelength. For these nanoshells, the excitation laser was tuned to the aggregate resonance wavelength and the SERS response did not follow the single nanoshell plasmon response.

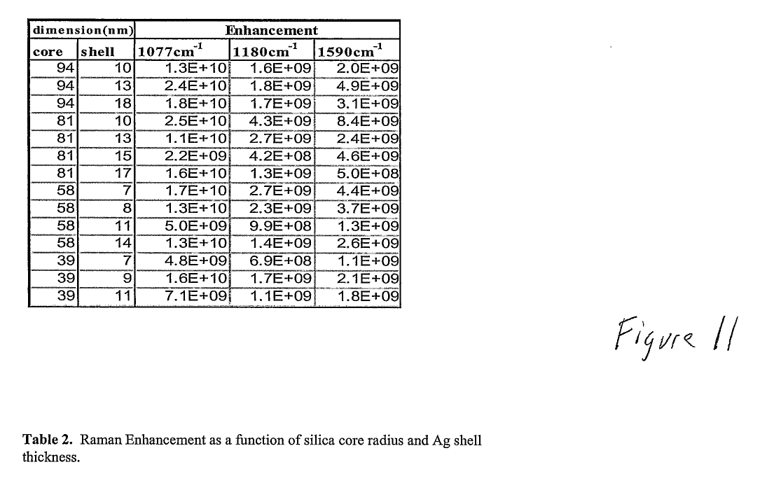

The Raman enhancement of these dense nanoshell films was determined experimentally following Eq. (1). The number of molecules in the enhanced sample was determined to be approximately 1.05×10⁶ molecules. The Raman enhancement for the 1077 cm⁻¹, 1180 cm⁻¹, and 1590 cm⁻¹ Stokes Raman modes as a function of core radius and shell thickness are shown in FIG. 11, which lists Raman Enhancement as a function of silica core radius and Ag shell thickness. These Raman enhancement values are consistent with the enhancement factors calculated in the nanoshell density analysis.

None of the conducted studies produced an overwhelmingly large SERS response due to a nanoshell dimer plasmon resonance, as is characteristic of the plasmon response of colloidal aggregate films. There are several possible reasons for this observation. Study observations clearly indicate that tuning the individual nanoshell peak on resonance with the pump laser results in the enhancement following the individual nanoshell SERS response. However, from field calculations it is known that the predicted enhancement in the junction between two nanoparticles is much larger than the single nanoshell near field enhancement, and that it also has a broader spectral response, so dimer plasmon resonances could be excited at the pump laser frequency used. The most likely explanation for the lack of a dimer plasmon contribution is that, in the dimer and small aggregates that are formed in these films, the junctions between particles are touching and too narrow to allow adsorbate molecules between the nanoparticles. Indeed, for nanoparticles as massive as nanoshells the interparticle forces are very strong; in the films studied to date, no observation has been made of nanoshell aggregates where the individual nanoparticles were less than a particle radius away but did not appear to be in direct contact.

It is also important to consider the effect of nanoscale roughness on the surface of the nanoshells and whether this surface roughness may be responsible for additional local field enhancements beyond the ideal case of the smooth spherical nanoshell described by Mie scattering theory.

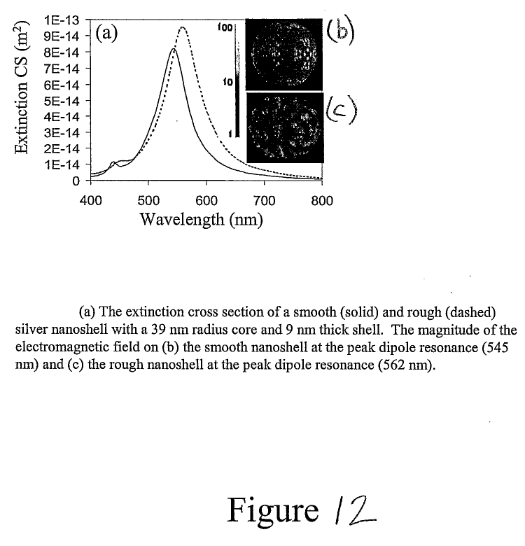

FDTD techniques were used to examine the electromagnetic response in both the near and far field for a smooth versus a roughened nanoshell FIG. 12, which displays in graph (a) the extinction cross section of a smooth (solid) and rough (dashed) silver nanoshell with a 39 nm radius core and 9 nm thick shell. The magnitude of the electromagnetic field on representation (b) is of the smooth nanoshell at the peak dipole resonance (545 nm) and representation (c) is the rough nanoshell at the peak dipole resonance (562 nm

For the topologies considered here, there was only a slight increase in local field intensities relative to the smooth shell local field at the peak of each respective nanoparticle's plasmon resonance. The plasmon extinction spectrum is largely independent of roughness (although a small spectral peak shift does occur) provided the metallic shell is complete (FIG. 7(a)). It is noted, however, that the near field just off the peak of the plasmon resonance falls off more sharply for a smooth nanoshell than for the roughened nanoshell topology considered here, which may lead to a slight increase of enhancement for the rougher nanostructure. When pinholes are introduced onto the nanoshell surface there is further local field enhancement, however, the far field plasmon response (i.e. the coupling between the near field at the nanoparticle surface and the input and output waves) is significantly reduced at the pump and Stokes wavelengths. Because the far field plasmon response for all the nanoshells utilized in these experiments corresponded well to that of a smooth nanoshell plasmon, and because of the systematic core-shell dependence observed in these experiments, it is concluded that pinholes in the shell layer are not likely to be contributing significantly to the SERS enhancements measured in this series of experiments.

While preferred embodiments of this invention have been shown and described, modifications thereof can be made by one skilled in the art without departing from the scope of this invention. The embodiments described herein are exemplary only and are not limiting. For example, while nanospheres comprising silica cores and silver shells are disclosed, it will be understood that other nanoparticles could be used instead, including but not limited to nanospheres with varying core and shell materials and thicknesses. In addition, while Raman responses have been described as one example of inelastic electromagnetic emissions, other embodiments of the invention may comprise other types of inelastic electromagnetic emissions. Accordingly, the scope of protection is not limited to the embodiments described herein, but is only limited by the claims that follow, the scope of which shall include all equivalents of the subject matter of the claims.

What is claimed is:

1. A substrate for enhanced electromagnetic spectroscopy of an analyte, said substrate comprising:
a solid support; and
a plurality of individual nanoparticles affixed to said solid support, wherein said individual nanoparticles are designed to have an increased electromagnetic field strength that is between a first frequency of an incident electromagnetic radiation and a second frequency of Raman response from said analyte; and
wherein said Raman response is enhanced by said individual nanoparticles.

2. The substrate of claim 1 wherein said individual nanoparticles have a plasmon resonance frequency that is between a first frequency of an incident electromagnetic radiation and a second frequency of Raman response from said analyte.

3. The substrate of claim 1 wherein said individual nanoparticles enhance said Raman response by a factor of at least 10⁷.

4. The substrate of claim 1 wherein the nanoparticle is a nanosphere comprising a shell surrounding a core material with a lower conductivity than the shell material, and the thickness of the core material and the thickness of the shell material are selected to generate said plasmon resonance frequency.

5. The substrate of claim 4 wherein the core is comprised of at least one of the following: silicon dioxide, gold sulfide, titanium dioxide, polymethyl methacrylate (PMMA), polystyrene, hydrogels, and macromolecules such as dendrimers.

6. The substrate of claim 4 wherein the shell is comprised of at least one of the following: gold, silver, copper, platinum, palladium, lead, and iron.

7. The substrate of claim 1 wherein the solid support is comprised of at least one of the following: an inert glass, a metal, a metal film, an oxide, and a living cell.

8. The substrate of claim 1 wherein the nanoparticle is bonded to the solid support covalently, electrostatically, or via adsorption.

9. The substrate of claim 1 wherein the solid support is a reflective surface.

10. The substrate of claim 1 wherein the nanoparticle is selected from among spherical or elliptical shells, hollow nanoshells, multilayer nanoshells, nanorods, nanostars nanotriangles, and nanocubes.

11. The substrate of claim 1 wherein the wavelength of said incident electromagnetic radiation is between 200 nm and 20 microns.

12. The substrate of claim 11 wherein the incident electromagnetic radiation is selected from among wavelengths that reduce the electromagnetic emission from molecules other than the analyte to be detected.

13. The substrate of claim 1 wherein the analyte is in a powder.

14. The substrate of claim 1 wherein the analyte is suspended in a liquid.

15. The substrate of claim 1 wherein the liquid is a biological fluid such as blood, cerebral spinal fluid, phlegm, mucous, and urine.

16. A substrate for surface enhanced Raman spectroscopy of an analyte, said substrate comprising:
a solid support; and
a plurality of individual nanoparticles affixed to said solid support,
wherein said individual nanoparticles are designed to have a peak electromagnetic field strength when illuminated with an excitation wavelength that is equal to or greater than 600 nm.

17. A method for carrying out electromagnetic spectroscopy of an analyte, said analyte having a Raman response at a first frequency, comprising:
providing a light source having a second frequency;
selecting a nanoshell configuration such that said nanoshell has a plasmon resonance frequency between said first frequency and said second frequency and providing a plurality of nanoshells having said configuration; and
providing a solid support and affixing said plurality of individual nanoparticles thereto;
wherein said Raman response is enhanced by said individual nanoparticles.

18. The method of claim 17, wherein said Raman response is enhanced by a factor of at least 10⁷.

19. The method of claim 17, further comprising:
exposing the analyte to a environmental condition;
providing an alteration in the environmental condition;
detecting a change in the Raman response from the analyte resulting from said alteration; and
determining the alteration in the environmental condition based on the change in the electromagnetic emission.

20. The method of claim 17 wherein said plurality of nanoparticles are bonded to the solid support covalently, electrostatically, or via adsorption.
